(19) United States
(12) Patent Application Publication
(10) Pub. No.: US 2022/0369682 A1
(43) Pub. Date: Nov. 24, 2022

(54) EMULSION GEL EMBEDDING FAT-SOLUBLE VITAMIN AND PULSED ELECTRIC FIELD BASED PRODUCTION METHOD THEREFOR

(71) Applicant: South China University of Technology, Guangzhou (CN)

(72) Inventors: Xin'an Zeng, Guangzhou (CN); Boru Chen, Guangzhou (CN); Jinlin Cai, Guangzhou (CN); Zhong Han, Guangzhou (CN)

(21) Appl. No.: 17/771,109

(22) PCT Filed: Oct. 22, 2020
(86) PCT No.: PCT/CN2020/122615

§ 371 Date: Apr. 22, 2022

(30) Foreign Application Priority Data
Oct. 23, 2019 (CN) 201911011058.5

(51) Int. Cl. A23L 29/262; A23L 33/155; A23L 5/30; A23L 29/30; A23L 33/135

(52) U.S. Cl. CPC A23L 29/262; A23L 33/155; A23L 5/30; A23L 29/30; A23L 33/135

(57) ABSTRACT

An emulsion gel embedding a fat-soluble vitamin and a pulsed electric field based production method therefor. The production method comprises: dissolving octenyl succinate starch ester in water, heating in a water bath, stirring to complete gelatinization and dissolution, and cooling to room temperature; adding edible oil dissolved with a fat-soluble vitamin to obtain a mixed liquid; shearing and homogenizing the obtained mixed liquid by using a high-speed shearing machine and a high-pressure homogenizer to obtain an emulsion; and adding the emulsion and natural starch to a methyl cellulose solution, performing pulsed electric field treatment after well mixing, heating in a water bath, performing degasification and cooling to obtain an emulsion gel. The pulsed electric field promotes interaction between methyl cellulose and starch molecules, has a higher elastic modulus, and is easier to form a network structure that is more conducive to embedding the fat-soluble vitamin.

### TECHNICAL FIELD

The present invention relates to a method for embedding a fat-soluble vitamin, particularly relates to a method for producing an emulsion gel embedding the fat-soluble vitamin by using a pulsed electric field, and belongs to the technical field of food engineering.

### BACKGROUND

Fat-soluble vitamin is a general term for a class of polypentadiene compounds composed of long hydrocarbon chains or fused rings, which can be divided into several categories such as vitamin A, vitamin D, vitamin E and vitamin K, and plays an important role in a process of regulating the growth, development and metabolism of organisms. However, most of the fat-soluble vitamin cannot be synthesized in the body or can be synthesized in insufficient amounts, and must be ingested from the daily diet. Nevertheless, the fat-soluble vitamin is organic compounds with large molecular weight, insoluble in water, difficult to be dispersed, and difficult to be absorbed by cells in the body, which greatly limits their application in the food industry. Furthermore, some fat-soluble vitamins are unstable when exposed to oxygen, acid and high temperature, and are easily affected by light, pH and oxygen during heat treatment or storage, which results in that the nutrient content in products is reduced, and its potential health benefits are not fully realized.

In order to solve the above limitations of the fat-soluble vitamin, scholars at home and abroad have successively embedded the fat-soluble vitamin in grease phases of amphiphilic delivery systems (emulsion, liposome, microcapsule or their modified structures), which can be administered orally, absorbed and utilized by the human body. However, 90% of the emulsion is usually digested during early 20 minutes after it reaches the small intestine, and it is difficult to achieve the effect of controlled release and sustained release of drug delivery by means of this excessively fast digestion rate, which makes the sustained release performance worse. Moreover, the emulsion is unstable in gastric juice, and part of its grease begins to precipitate in the stomach. When the grease present in a form of lipid reaches the small intestine, it is difficult to quickly contact a lipase at the oil-water interface, which inhibits the digestion rate of its grease, thereby reducing the absorption and utilization of the soluble vitamins.

Emulsion gel refers to a stable, homogeneous and transparent gel network structure formed by loading the emulsion into a gel matrix (protein, starch, or natural polymer). Compared with liquid emulsions, emulsion gels can form a three-dimensional network structure to effectively “embed” a fat-soluble vitamin, and the gel matrix can further isolate contact of the core material in the emulsion with oxygen gas, light and the like in the environment, which is beneficial to the protection of the nutrients in the emulsion, and can improve stability of the nutrients in the digestive tract, and the degree of fat digestion in emulsion gels and in vitro bioavailability of the fat-soluble vitamin are greater.

Most of the current researches use small molecule surfactants or proteins as emulsifiers to prepare emulsions, and add proteins or natural starches as gelatinizers to prepare emulsion gels. Chinese patent CN108669550A discloses a preparation method of myofibrillar protein emulsion gel. The protein stock solution and the xanthan gum stock solution are mixed and stirred for 2-4 hours, and the gel is obtained by thermal induction. Chinese patent CN108822309A discloses a preparation method for a composite hydrogel of nanofiber microemulsion. The cellulose is pretreated by mechanical methods such as ultrasonic, homogenization via a homogenizer, etc., and then mixed uniformly with the microemulsion to obtain a composite gel. Chinese patent CN108064976A discloses a polysaccharide emulsion gel. The regenerated cellulose suspension and the edible oil are homogenized to obtain an emulsion of the edible oil and the cellulose, and a curdlan gum is added into the emulsion, stirred, heated and cooled to obtain a polysaccharide emulsion gel. The preparation of these composite gels mostly adopts the simple stirring form to mix the two stock solutions evenly, the reaction takes long time and is insufficient, and the obtained emulsion gel has poor stability and low embedding rate. Lu Yao et al. use a glucono-δ-lactone-induced method to prepare an emulsion gel of whey protein isolate. It is necessary to control a time for the heat treatment to change the denaturation degree of protein so as to regulate and control the microstructure of the emulsion gel, which is prone to produce other by-products.

The disadvantages of these methods are:

(1) During the preparation process of the composite gel, only simple stirring form is used to mix the two stock solutions evenly, and the reaction takes long time and is insufficient.

(2) The emulsion gel has poor stability and low embedding rate.

(3) The preparation by adopting the induction method needs to control the time for the heat treatment to change the denaturation degree of protein so as to regulate and control the microstructure of the emulsion gel, which is prone to produce other by-products.

As one of the emerging non-thermal processing technologies for food, a high-voltage pulsed electric field technology has attracted attention of the broad masses of researchers at home and abroad due to its good application characteristics such as non-heat treatment, low energy consumption, time saving, high efficiency and good preservation effect on the original quality of food. Chinese invention patent CN106036394A discloses a method for producing starch-selenium polysaccharide, and selenium-enriched pregelatinized nutritional rice paste by using a pulsed electric field, which improves the selenium content in a starchy rice paste; Chinese invention patent CN105995947A discloses a method for producing a starch-zinc complex nutrition enhancer by utilizing a pulsed electric field, which improves the content and conversion rate of the metal in the starch-zinc complex, and simultaneously increases the content of the slowly digestible starch in the complex; and Chinese invention patent CN107501600A discloses a preparation method of a pulsed electric field-modified porous starch, which significantly improves the oil absorption, transparency and freeze-thaw stability of the porous starch. Chinese invention patent CN102627698A discloses a preparation method of a sweet potato carboxymethyl modified starch, which effectively improves the degree of substitution of the carboxymethyl starch. However, none of the above-mentioned prior art involves the preparation of emulsion gels by means of a pulsed electric field treatment.

### SUMMARY

In order to overcome the above-mentioned shortcomings and deficiencies of the prior art, the object of the present invention is to provide an emulsion gel that can embed a fat-soluble vitamin and a pulsed electric field based production method thereof, which is environmentally friendly, is produced by using a pulsed electric field with a short reaction time, low energy consumption, significantly improved emulsifying ability as well as stability of emulsion gels, and an encapsulation rate of 90% or more.

The object of the present invention is realized by the following technical solutions:

A pulsed electric field based production method for an emulsion gel embedding a fat-soluble vitamin, comprising the following preparation steps:

(1) dissolving a starch octenyl succinate in water, heating in a water bath, stirring to complete gelatinization and dissolution, and cooling to room temperature;

(2) adding an edible oil dissolved with a fat-soluble vitamin into a starch octenyl succinate solution in the step (1), preparing a crude emulsion by using a high-speed shearing machine, and then obtaining an emulsion via a high-pressure homogenizer;

(3) adding a starch into the emulsion, and stirring evenly, to obtain a mixed solution;

(4) adding a methylcellulose solution into the mixed solution prepared in the step (3), and performing a pulsed electric field treatment after stirring evenly, the pulsed electric field has an electric field strength of 5 to 15 kV/cm, and a frequency of 200 to 1000 Hz; and

(5) heating a total mixture after the pulsed electric field treatment in a water bath at 80 to 95° C. for 15 to 30 min, degassing, and cooling, to obtain an emulsion gel.

In order to further achieve the object of the present invention, preferably, in terms of percent by weight, in the step (1), a mass fraction of the starch octenyl succinate is 5% to 15%.

The fat-soluble vitamin is any one or more of retinol, β-carotene, lycopene, lutein, tocopherol, sterols, and vitamin K.

Preferably, the edible oil is any one or more of soybean oil, corn oil, peanut oil, rapeseed oil or olive oil.

Preferably, in terms of percent by weight, in the step (2), an adding amount of the fat-soluble vitamin is 0.02% to 0.1% of the mass of the emulsion; in the step (2), an adding amount of the edible oil is 5% to 25% of the volume of the emulsion.

Preferably, in the step (3), the mass ratio of the starch to the emulsion is 10 to 20:100. Preferably, in the step (4), the methylcellulose solution is obtained by dissolving a methylcellulose in a phosphate buffer of pH 7.0, wherein, a concentration of the methylcellulose is 0.2% to 0.5%.

Preferably, a weight ratio of the methylcellulose solution is 8% to 15% of the total mixture.

Preferably, the pulsed electric field treatment has a pulse width of 10 to 100 μs, a treatment time of 10 to 20 min, a waveform of a square wave, and a treatment temperature of 30 to 40° C.

An emulsion gel embedding a fat-soluble vitamin is produced by the above-mentioned production method, and the emulsion gel is a starch octenyl succinate-methylcellulose emulsion gel embedding the fat-soluble vitamin, which is used to replace saturated fatty acid, and as a delivery system of a functional factor to embed the fat-soluble vitamin and a probiotic.

Methylcellulose is a kind of indigestible polysaccharide, with superior characteristics of adhering property, thickening property, emulsifying property and forming a gel structure, and is usually used as a thickener and an emulsifier. Starch is the most common polysaccharide in the human diet. Starch is rich in content, inexpensive, safe, and easy to form a hydrogel after heating, which is suitable for preparing a food-grade filled hydrogel. With a methyl cellulose and starch compound as a gelatinizer, and starch octenyl succinate as an emulsifier, the original hydrogen-bond network within and between methylcellulose molecules is broken under the action of a bipolar pulsed electric field. The ordered crystalline region inside the methylcellulose becomes disordered, and an electrostatic repulsion force between methylcellulose molecules decreases, which promote the degree of crosslinking between methylcellulose and starch molecules increasing and forming new hydrogen bonds. Starch octenyl succinate is a surface-active polymer emulsifier, and simultaneously has the advantages of good emulsibility, wide application, high safety, edibility and biodegradability. Pores are formed on a molecular surface layer of starch octenyl succinate by using a fast pulse and high-voltage electric field, so that the solubility of starch octenyl succinate increases, and more octenyl succinate groups are exposed. Under the action of the electric field, the ions of the emulsion oil droplets move, which reduces the interfacial energy of the emulsion oil droplets, stabilizes the emulsion droplets, promotes the diffusion and penetration of the emulsion oil droplets within the pores of the gel network, makes the filling of the composite system more uniform and dense, and forms a stable three-dimensional network structure. The emulsion gel in the form of soft solid is obtained, so that the system not only has the ability to carry fat-soluble substances of the emulsion carrier system, but also has characteristics of the protection inner layer of the hydrogel carrier system to embed and carry substances to a designated position for digestion, and to control the release of internal nutrients, which improves the absorption and utilization of the fat-soluble vitamin within the human body. The present invention can effectively promote the dissolution of starch octenyl succinate through the pulsed electric field, reduce the interfacial tension of the emulsion, promote the compounding of methyl cellulose and starch, greatly exert the synergistic effect of methyl cellulose and starch, and significantly improve the emulsifying ability and stability of the emulsion gel with an encapsulation rate up to 90% or more, which can be applied to the development of functional foods.

Compared with the prior art, the present invention has the following advantages and beneficial effects:

(1) The present invention produces a novel starch-based emulsion gel by using the pulsed electric field, which is simple in its preparation process, environmentally friendly, and easy to control the reaction process.

(2) The present invention produces a novel starch-based emulsion gel by using the pulsed electric field, which shortens the reaction time, saves energy consumption and improves economic benefits.

(3) The present invention can effectively promote the solubility of starch octenyl succinate through the pulsed electric field, reduce the interfacial energy of the emulsion oil droplets, significantly improve the emulsifying ability and stability of the emulsion gel with the embedding rate up to 90% or more, and effectively improve the storage stability and bioavailability of the fat-soluble vitamin.

(4) The novel starch-based emulsion gel prepared by the present invention provides directional guidance for the effective construction of the semi-solid nutrient emulsion system, expands the practical application of the functional nutrient emulsion, can not only meet needs of people for high-quality nutriments, but also fill the gaps in the domestic food market, and has broad application prospects in the fields of foods, health care products, biomedicines, etc.

### DESCRIPTION OF DRAWINGS

FIG. 1 is an image for the finished product of the emulsion gel embedding lycopene in Example 1.

FIG. 2 is the effect of different strengths of the pulse electric field on the gelation time of the emulsion gels in the Examples of the present invention.

FIG. 3 is the rheological property curves of the emulsion gels embedding β-carotene in Example 2 and Comparative Example 1.

FIG. 4 is the effect of different strengths of the pulse electric field on the embedding rate of the emulsion gels in the Examples of the present invention.

FIG. 5 is the sustained release curves of β-carotene from the emulsion gels prepared in Comparative Example 1, Comparative Example 2 and Example 2 of the present invention in a simulated gastrointestinal fluid.

### DETAILED DESCRIPTION OF EMBODIMENTS

For a better understanding of the present invention, the present invention is further described below in conjunction with the attached drawings and Examples, but the embodiments of the present invention are not limited thereto.

Determining method for the embedding rate of the fat-soluble vitamin:

The method includes the following steps: weighing accurately 2.0 g of an emulsion gel sample containing a fat-soluble vitamin, adding 20 mL of anhydrous ethanol, ultrasonically extracting for 5 min and then filtering for 3 times, and combining the filtrate. An absorbance value of the fat-soluble vitamin is measured by using an ultraviolet spectrophotometer at the specific absorption wavelength of the fat-soluble vitamin, and a content of the fat-soluble vitamin is calculated in combination with a standard curve of the fat-soluble vitamin. It is calculated according to the following formula:

Embedding rate=(the content of the fat-soluble vitamin in the emulsion gel/an initial adding amount of the fat-soluble vitamin)×100%

### Example 1

Starch octenyl succinate was dissolved in water, placed in a boiled water bath and heated, stirred until it was completely gelatinized and dissolved, and cooled to room temperature. Lycopene-dissolved soybean oil was added to make the mixture contain 5% by mass of starch octenyl succinate, 0.1% by mass of lycopene and 10% by mass of soybean oil. A crude emulsion was prepared by using a high-speed disperser (IKA T25 high-speed disperser, Shanghai Shupei Experimental Equipment Co., Ltd.) with a shearing rotation speed of 15000 r/min and a shearing time of 2 min. Then, it was poured into a high-pressure homogenizer (M-110EH microfluidizer, American Microfluidics Company) and homogenized for 3 times under the condition of 80 Mpa, to obtain an emulsion. Then, a rice starch with a mass fraction of 8% was added, and mixed evenly, to obtain a mixed solution.

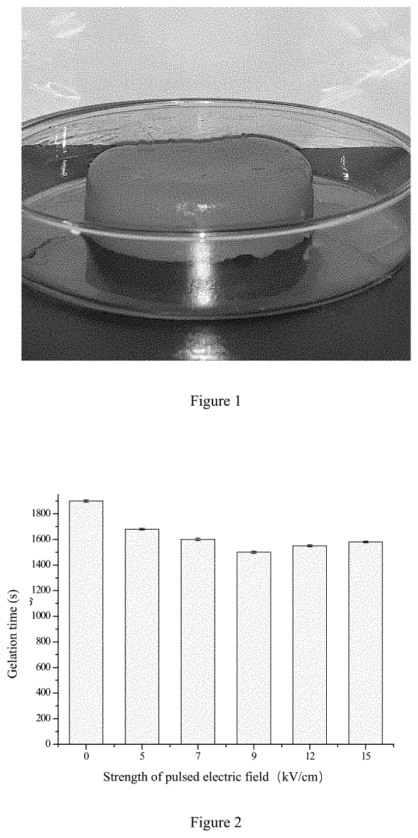

Methylcellulose was dissolved in a phosphate buffer (10 mM, pH 7.0), to prepare a methylcellulose solution with a mass concentration of 0.5%. After the prepared mixed solution and the methylcellulose solution were mixed uniformly at a ratio of 6:1 (w/w), the total mixture was treated for 20 min by means of a pulsed electric field (pulsed electric field SY-200, Guangzhou Xinan Food Technology Co., Ltd.), with a pulse frequency of 300 Hz, a pulse width of 100 μs, a pulse field strength of 5 kV/cm, and a treatment temperature of 30° C. Then, it was placed and heated in a hot water bath at 85° C. for 15 min, added into a cylindrical plastic test tube, degassed, sealed, and placed in an ice-water bath to cool down, to obtain an emulsion gel. FIG. 1 was the appearance of the lycopene-embedded emulsion gel prepared in Example 1. A gelation time of this emulsion gel was 1680 s, a maximum storage modulus in the test range of a frequency of 0.01 to 10 Hz was 1463 pa, and an embedding rate of lycopene by the emulsion gel reached 95.76%.

The forming time and the storage modulus of the emulsion gel were monitored by a rheometer, the emulsion gel samples were placed respectively between parallel plates, a gap between two plates was set to 3 mm, and a test temperature was 25° C. A storage modulus (G′) was determined as a function of time with a strain of 0.1%, a frequency of 1 Hz, and a testing time of 2 h. After the end of a time sweep, a frequency sweep was immediately performed with a frequency sweep range of 0.01 to 10 Hz and a strain of 0.1%. The gelation time was defined as the time corresponding to G′ greater than or equal to 1 Pa, and the result shows that the gelation time of this emulsion gel was 1680 s, which was shorter than that of the emulsion gel without a pulsed electric field treatment, which was 1900 s, and the data are shown in FIG. 2. FIG. 2 showed the effects of different strengths of pulsed electric field on the gelation time of starch octenyl succinate-methylcellulose emulsion gel under the above-mentioned conditions. It was illustrated that a pretreatment with the pulsed electric field could break an original hydrogen-bond network within and between methylcellulose molecules, and could promote the exposure of active groups in more starch molecules, so that the viscosity of the system increased and the formation of the gel network structure accelerated.

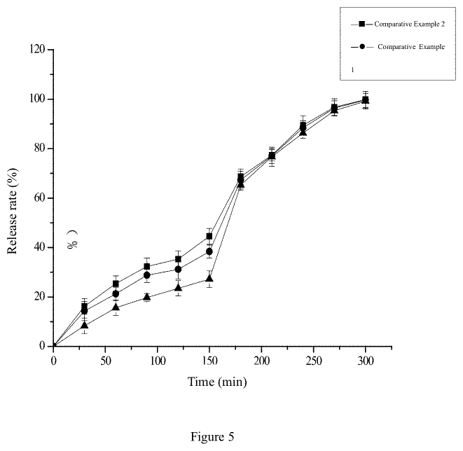

According to the test, the embedding rate of lycopene by this emulsion gel reached 95.76%, and the data was shown in FIG. 4. FIG. 4 showed the effects of the starch octenyl succinate-methylcellulose emulsion gel on the embedding rate of lycopene at different strengths of the pulsed electric field under the above-mentioned conditions. A high embedding rate made it difficult for a fat-soluble vitamin to undergo oxidation reactions with free radicals and metal ions in the water phase, which improved the storage stability of the fat-soluble vitamin; during a digestion process, dissolution and absorption of the fat-soluble vitamin in micelles was promoted, and a bioavailability of the fat-soluble vitamin increased.

### Example 2

Starch octenyl succinate was dissolved in water, placed in a boiled water bath and heated, stirred until it was completely gelatinized and dissolved, and cooled to room temperature. Corn oil with suitable amount of β-carotene dissolved was added to make the mixture contain 5% by mass of starch octenyl succinate, 0.02% by mass of β-carotene and 10% by mass of corn oil. A crude emulsion was prepared by using a high-speed disperser (IKA T25 high-speed disperser, Shanghai Shupei Experimental Equipment Co., Ltd.) with a shearing rotation speed of 15000 r/min and a shearing time of 2 min. Then, it was poured into a high-pressure homogenizer (M-110EH microfluidizer, American Microfluidics Company) and homogenized for 3 times under the condition of 80 Mpa, to obtain an emulsion. Then, a corn starch with a mass fraction of 10% was added, and mixed evenly, to obtain a mixed solution.

Methylcellulose was dissolved in a phosphate buffer (10 mM, pH 7.0), to prepare a methylcellulose solution with a mass concentration of 0.5%. After the prepared mixed solution and the methylcellulose solution were mixed uniformly at a ratio of 8:1 (w/w), the total mixture was treated for 15 min with a pulsed electric field (pulsed electric field SY-200, Guangzhou Xinan Food Technology Co., Ltd.) with a pulse frequency of 600 Hz, a pulse width of 40 μs, a pulse field strength of 9 kV/cm, and a treatment temperature of 35° C. Then, it was placed in a hot water bath at 85° C. and heated for 15 min, added into a cylindrical plastic test tube, degassed, sealed, placed in an ice-water bath to cool down, and solidified to obtain an emulsion gel. A gelation time of this emulsion gel was 1500 s, a maximum storage modulus in the test range of a frequency of 0.01 to 10 Hz was 1472 pa, and an embedding rate of β-carotene by the emulsion gel reached 96.39%.

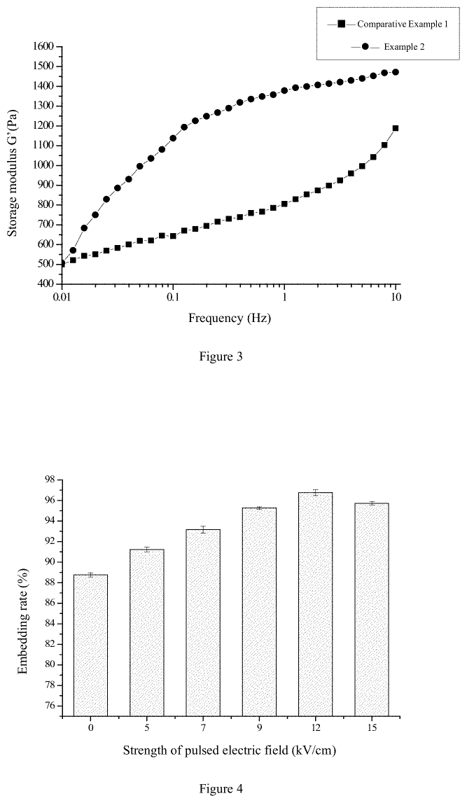

FIG. 3 is the rheological property curves of the emulsion gels in Example 2 and Comparative Example 1 which has not been treated with a pulsed electric field. An increase in the storage modulus G′ during the emulsion gelation process was considered to be an indication of an increase in the strength or hardness of the emulsion gel. As shown in FIG. 3, a maximum storage modulus in the test range of a frequency of 0.01 to 10 Hz of this emulsion gel was 1472 Pa, which was higher than the maximum storage modulus of 1200 Pa of the emulsion gel that have not been treated with a pulsed electric field, indicating that the pulsed electric field pretreatment can improve the storage modulus of the emulsion gel, and enhance the elastic strength of the emulsion gel.

### Example 3

Starch octenyl succinate was dissolved in water, placed in a boiled water bath and heated, stirred until it was completely gelatinized and dissolved, and cooled to room temperature. Peanut oil with suitable amount of tocopherol dissolved was added to make the mixture contain 10% by mass of starch octenyl succinate, 0.08% by mass of tocopherol and 20% by mass of peanut oil. A crude emulsion was prepared by using a high-speed disperser (IKA T25 high-speed disperser, Shanghai Shupei Experimental Equipment Co., Ltd.) with a shearing rotation speed of 15000 r/min and a shearing time of 2 min. Then, it was poured into a high-pressure homogenizer (M-110EH microfluidizer, American Microfluidics Company) and homogenized for 3 times under the condition of 80 Mpa, to obtain an emulsion. Then, a potato starch with a mass fraction of 12% was added, and mixed evenly, to obtain a mixed solution.

Methylcellulose was dissolved in a phosphate buffer (10 mM, pH 7.0), to prepare a methylcellulose solution with a mass concentration of 3%. After the prepared mixed solution and the methylcellulose solution were mixed uniformly at a ratio of 12:1 (w/w), the total mixture was treated for 12 min with a pulsed electric field (pulsed electric field SY-200, Guangzhou Xinan Food Technology Co., Ltd.) with a pulse frequency of 1000 Hz, a pulse width of 10 μs, a pulse field strength of 12 kV/cm, and a treatment temperature of 30° C. Then, it was placed in a hot water bath at 85° C. and heated for 15 min, added into a cylindrical plastic test tube, degassed, sealed, placed in an ice-water bath to cool down, and solidified to obtain an emulsion gel. A gelation time of this emulsion gel was 1550 s, a maximum storage modulus of this emulsion gel in the test range of a frequency of 0.01 to 10 Hz was 1415 pa, and an embedding rate of tocopherol by the emulsion gel reached 93.54%.

### Example 4

Starch octenyl succinate was dissolved in water, placed in a boiled water bath and heated, stirred until it was completely gelatinized and dissolved, and cooled to room temperature. Rapeseed oil with suitable amount of lutein dissolved was added to make the mixture contain 15% by mass of starch octenyl succinate, 0.06% by mass of lutein and 15% by mass of rapeseed oil. A crude emulsion was prepared by using a high-speed disperser (IKA T25 high-speed disperser, Shanghai Shupei Experimental Equipment Co., Ltd.) with a shearing rotation speed of 15000 r/min and a shearing time of 2 min. Then, it was poured into a high-pressure homogenizer (M-110EH microfluidizer, American Microfluidics Company) and homogenized for 3 times under the condition of 80 Mpa, to obtain an emulsion. Then, a cassava starch with a mass fraction of 18% was added, and mixed evenly, to obtain a mixed solution.

Methylcellulose was dissolved in a phosphate buffer (10 mM, pH 7.0), to prepare a methylcellulose solution with a mass concentration of 5%. After the prepared mixed solution and the methylcellulose solution were mixed uniformly at a ratio of 12:1 (w/w), the total mixture was treated for 10 min with a pulsed electric field (pulsed electric field SY-200, Guangzhou Xinan Food Technology Co., Ltd.) with a pulse frequency of 200 Hz, a pulse width of 80 μs, a pulse field strength of 15 kV/cm, and a treatment temperature of 40° C. Then, the above-mentioned mixture was placed in a hot water bath at 85° C. and heated for 15 min, added into a cylindrical plastic test tube, degassed, sealed, placed in an ice-water bath to cool down, and solidified to obtain an emulsion gel. A gelation time of this emulsion gel was 1570 s, a maximum storage modulus of this emulsion gel in the test range of a frequency of 0.01 to 10 Hz was 1550 pa, and an embedding rate of lutein by the emulsion gel reached 92.28%.

### Comparative Example 1

A preparation method for an emulsion gel, comprised the following steps:

Starch octenyl succinate was dissolved in water, placed in a boiled water bath and heated, stirred until it was completely gelatinized and dissolved, and cooled to room temperature. Corn oil with suitable amount of β-carotene dissolved was added to make the mixture contain 5% by mass of starch octenyl succinate, 0.02% by mass of β-carotene and 10% by mass of corn oil. A crude emulsion was prepared by using a high-speed disperser (IKA T25 high-speed disperser, Shanghai Shupei Experimental Equipment Co., Ltd.) with a shearing rotation speed of 15000 r/min and a shearing time of 2 min. Then, it was poured into a high-pressure homogenizer (M-110EH microfluidizer, American Microfluidics Company) and homogenized for 3 times under the condition of 80 Mpa, to obtain an emulsion. Then, a corn starch with a mass fraction of 10% was added, and mixed evenly, to obtain a mixed solution.

Methylcellulose was dissolved in a phosphate buffer (10 mM, pH 7.0), to prepare a methylcellulose solution with a mass concentration of 0.5%. After the prepared mixed solution and the methylcellulose solution were mixed uniformly at a ratio of 8:1 (w/w), it was placed in a hot water bath at 85° C. and heated for 15 min, added into a cylindrical plastic test tube, degassed, sealed, placed in an ice-water bath to cool down, and solidified to obtain an emulsion gel. A gelation time of this emulsion gel was 1910 s, a maximum storage modulus of this emulsion gel in the test range of a frequency of 0.01 to 10 Hz was 1200 pa, and an embedding rate of β-carotene by the emulsion gel reached 85.27%.

### Comparative Example 2

Starch octenyl succinate was dissolved in water, placed in a boiled water bath and heated, stirred until it was completely gelatinized and dissolved, and cooled to room temperature. Corn oil with β-carotene dissolved was added to make the mixture contain 5% by mass of starch octenyl succinate, 0.02% by mass of β-carotene and 10% by mass of corn oil. A crude emulsion was prepared by using a high-speed disperser (IKA T25 high-speed disperser, Shanghai Shupei Experimental Equipment Co., Ltd.) with a shearing rotation speed of 15000 r/min and a shearing time of 2 min. Then, it was poured into a high-pressure homogenizer (M-110EH microfluidizer, American Microfluidics Company) and homogenized for 3 times under the condition of 80 Mpa, to obtain an emulsion. Then, a corn starch with a mass fraction of 10% was added, and mixed evenly. Then, it was placed in a hot water bath at 85° C. and heated for 15 min, added into a cylindrical plastic test tube, degassed, sealed, placed in an ice-water bath to cool down, and solidified to obtain an emulsion gel. A gelation time of this emulsion gel was 2014 s, a maximum storage modulus of this emulsion gel in the test range of a frequency of 0.01 to 10 Hz was 1183 pa, and an embedding rate of β-carotene by the emulsion gel reached 82.29%.

Implementation effect: The gelation times of Comparative Example 1 and Comparative Example 2 were longer than that of Example 2, and the elastic moduli of Comparative Example 1 and Comparative Example 2 were lower than that of Example 2, indicating that the pulse electric field pretreatment accelerated the formation of the gel network structure, and enhanced the elasticity of the gel. In Comparative Example 1, the embedding rate of β-carotene by the emulsion gel without pulsed electric field treatment reached 85.27%; and in Comparative Example 2, the emulsion gel was prepared by using starch octenyl succinate and natural starch as raw materials, and without adding methylcellulose, and its embedding rate of β-carotene was 82.29%, which were lower than the embedding rate, 95.76% of β-carotene by the emulsion gel subjected to the action of the pulsed electric field in Example 2. This indicates that the use of the pulsed electric field gelation pretreatment has a good embedding effect on the fat-soluble vitamin, and the compounding of methylcellulose and starch can synergize, and inhibit the flocculation of lipid droplets, and it is not easy for the fat-soluble vitamin to undergo oxidation reaction with free radicals and metal ions etc. in the water phase, which enhanced the storage stability of the fat-soluble vitamin and significantly improved the properties of the emulsion gel.

FIG. 5 is the sustained release curves of β-carotene in simulated gastrointestinal fluid. The effects of the emulsion gels obtained in Example 2, Comparative Example 1, and Comparative Example 2 on sustained release of β-carotene were studied. The experimental method was: dissolving 2 g of NaCl and 7 mL of HCl with a concentration of 37% in 1 L of water, adding 3.2 g of pepsin to prepare a gastric digestive juice, taking 1 g of the sample, mixing it with 10 mL of simulated gastric digestive juice, adjusting the pH to 2.5 at 37° C., performing a reaction at a speed of 100 r/min, respectively adding sodium phosphate to adjust the pH of the solution to 6.8 after 0, 30, 60, 90, 120, 150 min, weighing 6.8 g of KH₂PO₄, adding 600 mL of distilled water to dissolve it, then adjusting the pH to 6.8 with NaOH solution, adding 10 g of trypsin, dissolving, and diluting to 1000 mL with water. In this simulated intestinal fluid, the release degree of β-carotene was continued to be measured within 2.5 h, and samples were taken every 30 min. The absorbance was measured at 472 nm, and the release degree was calculated according to the standard curve of (3-carotene. The experimental results were shown in FIG. 5. It can be seen from FIG. 5 that the release rate of the emulsion gel treated with the pulsed electric field in the stomach was slower than those of the emulsion gels in Comparative Example 1 and Comparative Example 2 within 150 min. After reaching the intestinal tract, the release rate can reach more than 90%, realizing the sustained release of β-carotene.

In the present invention, the pulsed electric field can promote the interaction between methylcellulose and starch molecules. The system has a higher elastic modulus, and it is easier to form a network structure that is more conducive to embedding the fat-soluble vitamin. The network structure synergistically formed by methylcellulose and starch can effectively “embed” the fat-soluble vitamin, and reduce the speed of outward diffusion of the fat-soluble vitamin and other functional factors after dissolution, so as to achieve the purpose of slow release of the fat-soluble vitamin, and make it has certain sustained release and targeted delivery functions, improve its bioavailability within the body, and contain dietary fiber that is beneficial to health, which can meet needs of people for nutrition, health, and diversification of foods. It has potential application values in foods, health care products, biomedicines and other fields, and simultaneously has opened up a new way to research and develop new food base materials and improve the processing characteristics of foods, which leads to a good market prospect.

The embodiments of the present invention are not limited by the examples, and any other changes, modifications, substitutions, combinations, and simplifications made without departing from the spirit and principle of the present invention should be equivalent replacement modes, and included in the protection scope of the present invention.

1. A pulsed electric field based production method for an emulsion gel embedding a fat-soluble vitamin, characterized in that, the method comprises following preparation steps:
(1) dissolving a starch octenyl succinate in water, heating in a water bath, stirring to complete gelatinization and dissolution, and cooling to room temperature;
(2) adding an edible oil dissolved with a fat-soluble vitamin to a starch octenyl succinate solution in the step (1), preparing a crude emulsion by using a high-speed shearing machine, and then obtaining an emulsion via a high-pressure homogenizer;
(3) adding a starch into the emulsion, and stirring evenly, to obtain a mixed solution;
(4) adding a methylcellulose solution into the mixed solution prepared in the step (3), and performing a pulsed electric field treatment after stirring evenly, the pulsed electric field has an electric field strength of 5 to 15 kV/cm, and a frequency of 200 to 1000 Hz; and
(5) heating a total mixture after the pulsed electric field treatment in a water bath at 80 to 95° C. for 15 to 30 min, degassing, and cooling, to obtain an emulsion gel.

2. The production method according to claim 1, characterized in that, in the step (1), a mass fraction of the starch octenyl succinate in terms of percent by weight is 5% to 15%.

3. The production method according to claim 1, characterized in that, the fat-soluble vitamin is any one or more of retinol, β-carotene, lycopene, lutein, tocopherol, sterols, and vitamin K.

4. The production method according to claim 1, characterized in that, the edible oil is any one or more of soybean oil, corn oil, peanut oil, rapeseed oil or olive oil.

5. The production method according to claim 1, characterized in that, in the step (2), an adding amount of the fat-soluble vitamin in terms of percent by weight is 0.02% to 0.1% of the mass of the crude emulsion; in the step (2), an adding amount of the edible oil is 5% to 25% of the volume of the crude emulsion.

6. The production method according to claim 1, characterized in that, in the step (3), the mass ratio of the starch to the emulsion is 10 to 20:100.

7. The production method according to claim 1, characterized in that, in the step (4), the methylcellulose solution is obtained by dissolving a methylcellulose in a phosphate buffer having a pH of 7.0, wherein, a concentration of the methylcellulose is 0.2% to 0.5%.

8. The production method according to claim 1, characterized in that, a weight ratio of the methylcellulose solution to the total mixture is 8% to 15%.

9. The production method according to claim 1, characterized in that, the pulsed electric field treatment has a pulsed width of 10 to 100 μs, a treatment time of 10 to 20 min, a waveform of a square wave, and a treatment temperature of 30 to 40° C.

10. An emulsion gel embedding a fat-soluble vitamin, characterized in that, it is produced by the production method according to claim 1, and the emulsion gel is a starch octenyl succinate-methylcellulose emulsion gel embedding the fat-soluble vitamin, which is used to replace a saturated fatty acid, and as a delivery system of a functional factor to embed the fat-soluble vitamin and a probiotic.

11. An emulsion gel embedding a fat-soluble vitamin, characterized in that, it is produced by the production method according to claim 2, and the emulsion gel is a starch octenyl succinate-methylcellulose emulsion gel embedding the fat-soluble vitamin, which is used to replace a saturated fatty acid, and as a delivery system of a functional factor to embed the fat-soluble vitamin and a probiotic.

12. An emulsion gel embedding a fat-soluble vitamin, characterized in that, it is produced by the production method according to claim 3, and the emulsion gel is a starch octenyl succinate-methylcellulose emulsion gel embedding the fat-soluble vitamin, which is used to replace a saturated fatty acid, and as a delivery system of a functional factor to embed the fat-soluble vitamin and a probiotic.

13. An emulsion gel embedding a fat-soluble vitamin, characterized in that, it is produced by the production method according to claim 4, and the emulsion gel is a starch octenyl succinate-methylcellulose emulsion gel embedding the fat-soluble vitamin, which is used to replace a saturated fatty acid, and as a delivery system of a functional factor to embed the fat-soluble vitamin and a probiotic.

14. An emulsion gel embedding a fat-soluble vitamin, characterized in that, it is produced by the production method according to claim 5, and the emulsion gel is a starch octenyl succinate-methylcellulose emulsion gel embedding the fat-soluble vitamin, which is used to replace a saturated fatty acid, and as a delivery system of a functional factor to embed the fat-soluble vitamin and a probiotic.

15. An emulsion gel embedding a fat-soluble vitamin, characterized in that, it is produced by the production method according to claim 6, and the emulsion gel is a starch octenyl succinate-methylcellulose emulsion gel embedding the fat-soluble vitamin, which is used to replace a saturated fatty acid, and as a delivery system of a functional factor to embed the fat-soluble vitamin and a probiotic.

16. An emulsion gel embedding a fat-soluble vitamin, characterized in that, it is produced by the production method according to claim 7, and the emulsion gel is a starch octenyl succinate-methylcellulose emulsion gel embedding the fat-soluble vitamin, which is used to replace a saturated fatty acid, and as a delivery system of a functional factor to embed the fat-soluble vitamin and a probiotic.

17. An emulsion gel embedding a fat-soluble vitamin, characterized in that, it is produced by the production method according to claim 8, and the emulsion gel is a starch octenyl succinate-methylcellulose emulsion gel embedding the fat-soluble vitamin, which is used to replace a saturated fatty acid, and as a delivery system of a functional factor to embed the fat-soluble vitamin and a probiotic.

18. An emulsion gel embedding a fat-soluble vitamin, characterized in that, it is produced by the production method according to claim 9, and the emulsion gel is a starch octenyl succinate-methylcellulose emulsion gel embedding the fat-soluble vitamin, which is used to replace a saturated fatty acid, and as a delivery system of a functional factor to embed the fat-soluble vitamin and a probiotic.
